(19) United States
(12) Patent Application Publication
(10) Pub. No.: US 2022/0269924 A1
(43) Pub. Date: Aug. 25, 2022

(54) SYSTEM AND METHOD FOR PREDICTING TASK COMPLETION OF VOICE ASSISTANT FROM ONLINE USER LOGS

(71) Applicant: SAMSUNG ELECTRONICS CO., LTD., Suwon-si (KR)

(72) Inventors: Tapas Kanungo, Redmond, WA (US); Nehal Bengre, Cupertino, CA (US)

(73) Assignee: SAMSUNG ELECTRONICS CO., LTD., Suwon-si (KR)

(21) Appl. No.: 17/495,083

(22) Filed: Oct. 6, 2021

Related U.S. Application Data
(60) Provisional application No. 63/153,904, filed on Feb. 25, 2021.

(51) Int. Cl. G06N 3/04

(52) U.S. Cl. CPC G06N 3/0454

(57) ABSTRACT

A method for predicting a task completion of a voice assistant from online user logs may include obtaining a voice assistant log regarding a user voice input of a user of an electronic device requesting a voice assistant of the electronic device to perform a task; extracting a set of features from the voice assistant log; and identifying a task completion estimation metric that is indicative of a performance of the voice assistant in performing the task, based on the set of features and a trained artificial intelligence (AI) model.

### CROSS-REFERENCE TO RELATED APPLICATION(S)

This application is based on and claims priority under 35 U.S.C. § 119 to U.S. Provisional Patent Application No. 63/153,904, filed on Feb. 25, 2021, in the U.S. Patent & Trademark Office, the disclosure of which is incorporated by reference herein in its entirety.

### BACKGROUND

### 1. Field

The disclosure relates to a system and method for identifying a task completion estimation metric that is indicative of a performance of a voice assistant in performing a requested task, based on a set of features extracted from a voice assistant log and a trained artificial intelligence (AI) model.

### 2. Description of Related Art

A voice assistant may refer to a software agent that is configured to perform a task based on a user voice input. For example, a user may provide a user voice input to an electronic device requesting a voice assistant of the electronic device to perform a task, and the voice assistant may perform the task based on the user voice input. As an example, the user may provide a user voice input of “call dad,” and the voice assistant may cause the electronic device to call the requested contact.

A user's satisfaction with the voice assistant may vary based on whether the voice assistant performs the task. For example, a user may be satisfied with the voice assistant if the voice assistant performs the task, and the user may be dissatisfied with the voice assistant if the voice assistant is unable to perform the task. Also, the users satisfaction with the voice assistant may vary based on the extent and manner of interaction between the user and the voice assistant. For example, the user may be more satisfied with the voice assistant if the voice assistant performs the task directly in response to a single user voice input, whereas the user may be less satisfied with the voice assistant if the voice assistant performs the task after requiring the user to input multiple user voice inputs.

Identifying a users satisfaction with a voice assistant may be impractical, time consuming, and/or may require a significant amount of processing resources.

### SUMMARY

According to an aspect of an example embodiment, a method may include obtaining a voice assistant log regarding a user voice input of a user of an electronic device requesting a voice assistant of the electronic device to perform a task; extracting a set of features from the voice assistant log; and identifying a task completion estimation metric that is indicative of a performance of the voice assistant in performing the task, based on the set of features and a trained artificial intelligence (AI) model.

According to an aspect of an example embodiment, a device may include a memory configured to store instructions; and a processor configured to execute the instructions to: obtain a voice assistant log regarding a user voice input of a user of an electronic device requesting a voice assistant of the electronic device to perform a task; extract a set of features from the voice assistant log; and identify a task completion estimation metric that is indicative of a performance of the voice assistant in performing the task, based on the set of features and a trained artificial intelligence (AI) model.

According to an aspect of an example embodiment, a non-transitory computer-readable medium may store instructions that, when executed by one or more processors of an electronic device, cause the one or more processors to: obtain a voice assistant log regarding a user voice input of a user of an electronic device requesting a voice assistant of the electronic device to perform a task; extract a set of features from the voice assistant log; and identify a task completion estimation metric that is indicative of a performance of the voice assistant in performing the task, based on the set of features and a trained artificial intelligence (AI) model.

The set of features may include a latency value of the user voice input and a response of the voice assistant.

The set of features may include an application associated with the task.

The set of features may include a day of a week of the user voice input.

The set of features may include an hour of a day of the user voice input.

The set of features may include a first bidirectional encoder representations from transformers (BERT) embedding for the user voice input, and a second BERT embedding for a response of the voice assistant.

The set of features may include a sentiment of the user voice input.

The set of features may include a similarity value between the user voice input and a subsequent user voice input.

The set of features may include an identifier of whether the user voice input includes an interrogative word.

The set of features may include a number of stop words of the user voice input.

The set of features may include a number of words of the user voice input.

The trained AI model may be trained using training virtual assistant logs that are paired with known task completion estimation metrics.

The task completion estimation metric may be indicative of a user satisfaction with the voice assistant.

An action may be performed based on the task completion estimation metric.

Additional aspects will be set forth in part in the description that follows and, in part, will be apparent from the description, or may be learned by practice of the presented embodiments of the disclosure.

### BRIEF DESCRIPTION OF THE DRAWINGS

The above and other aspects, features, and aspects of embodiments of the disclosure will be more apparent from the following description taken in conjunction with the accompanying drawings, in which:

FIG. 1 is a diagram of a system for training an AI model, and identifying a task completion estimation metric using the trained AI model according to an example embodiment;

FIG. 2 is a diagram of a process of training an AI model, and identifying a task completion estimation metric using the trained AI model according to an example embodiment;

FIG. 3 is a flowchart of a process of identifying a task completion estimation metric using a trained AI model according to an example embodiment; and

FIG. 4 is a diagram of voice assistant logs associated with task completion estimation metrics according to an example embodiment.

### DETAILED DESCRIPTION

The following detailed description of example embodiments refers to the accompanying drawings. The same reference numbers in different drawings may identify the same or similar elements.

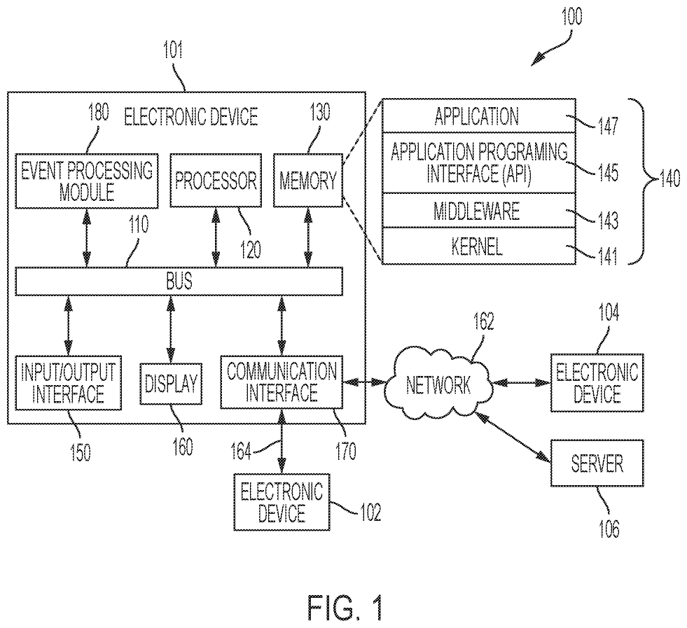

FIG. 1 is a diagram of a system for training an AI model, and identifying a task completion estimation metric using the trained AI model according to an example embodiment.

Referring to FIG. 1, according to an embodiment of the present disclosure, an electronic device 101 is included in a network environment 100. The electronic device 101 may include at least one of a bus 110, a processor 120, a memory 130, an input/output interface 150, a display 160, a communication interface 170, or an event processing module 180. In some embodiments, the electronic device 101 may exclude at least one of the components or may add another component.

The bus 110 may include a circuit for connecting the components 120 to 180 with one another and transferring communications (e.g., control messages and/or data) between the components.

The processor 120 may include one or more of a central processing unit (CPU), an application processor (AP), or a communication processor (CP). The processor120 may perform control on at least one of the other components of the electronic device 101, and/or perform an operation or data processing relating to communication.

The memory 130 may include a volatile and/or non-volatile memory. For example, the memory 130 may store commands or data related to at least one other component of the electronic device 101. According to an embodiment of the present disclosure, the memory 130 may store software and/or a program 140. The program 140 may include, e.g., a kernel 141, middleware 143, an application programming interface (API) 145, and/or an application program (or “application”) 147. At least a portion of the kernel 141, middleware 143, or API 145 may be denoted an operating system (OS).

For example, the kernel 141 may control or manage system resources (e.g., the bus 110, processor 120, or a memory 130) used to perform operations or functions implemented in other programs (e.g., the middleware 143, API 145, or application program 147). The kernel 141 may provide an interface that allows the middleware 143, the API 145, or the application 147 to access the individual components of the electronic device 101 to control or manage the system resources.

The middleware 143 may function as a relay to allow the API 145 or the application 147 to communicate data with the kernel 141, for example. A plurality of applications 147 may be provided. The middleware 143 may control work requests received from the applications 147, e.g., by allocation the priority of using the system resources of the electronic device 101 (e.g., the bus 110, the processor 120, or the memory 130) to at least one of the plurality of applications 134.

The API 145 is an interface allowing the application 147 to control functions provided from the kernel 141 or the middleware 143. For example, the API 133 may include at least one interface or function (e.g., a command) for filing control, window control, image processing or text control.

The input/output interface 150 may serve as an interface that may, e.g., transfer commands or data input from a user or other external devices to other component(s) of the electronic device 101. Further, the input/output interface 150 may output commands or data received from other component(s) of the electronic device 101 to the user or the other external device.

The display 160 may include, e.g., a liquid crystal display (LCD), a light emitting diode (LED) display, an organic light emitting diode (OLED) display, or a microelectromechanical systems (MEMS) display, or an electronic paper display. The display 160 may display, e.g., various contents (e.g., text, images, videos, icons, or symbols) to the user. The display 160 may include a touchscreen and may receive, e.g., a touch, gesture, proximity or hovering input using an electronic pen or a body portion of the user.

For example, the communication interface 170 may set up communication between the electronic device 101 and an external electronic device (e.g., a first electronic device 102, a second electronic device 104, or a server 106). For example, the communication interface 170 may be connected with the network 162 or 164 through wireless or wired communication to communicate with the external electronic device.

The first external electronic device 102 or the second external electronic device 104 may be a wearable device or an electronic device 101—mountable wearable device (e.g., a head mounted display (HMD)). When the electronic device 101 is mounted in a HMD (e.g., the electronic device 102), the electronic device 101 may detect the mounting in the HMD and operate in a virtual reality mode. When the electronic device 101 is mounted in the electronic device 102 (e.g., the HMD), the electronic device 101 may communicate with the electronic device 102 through the communication interface 170. The electronic device 101 may be directly connected with the electronic device 102 to communicate with the electronic device 102 without involving with a separate network.

The wireless communication may use at least one of, for example, 5G, long term evolution (LTE), long term evolution-advanced (LTE-A), code division multiple access (CDMA), wideband code division multiple access (WCDMA), universal mobile telecommunication system (UMTS), wireless broadband (WiBro), or global system for mobile communication (GSM), as a cellular communication protocol. The wired connection may include at least one of universal serial bus (USB), high definition multimedia interface (HDMI), recommended standard 232 (RS-232), or plain old telephone service (POTS).

The network 162 may include at least one of communication networks, e.g., a computer network (e.g., local area network (LAN) or wide area network (WAN)), Internet, or a telephone network.

The first and second external electronic devices 102 and 104 each may be a device of the same or a different type from the electronic device 101. According to an embodiment of the present disclosure, the server 106 may include a group of one or more servers. According to an embodiment of the present disclosure, all or some of operations executed on the electronic device 101 may be executed on another or multiple other electronic devices (e.g., the electronic devices 102 and 104 or server 106). According to an embodiment of the present disclosure, when the electronic device 101 should perform some function or service automatically or at a request, the electronic device 101, instead of executing the function or service on its own or additionally, may request another device (e.g., electronic devices 102 and 104 or server 106) to perform at least some functions associated therewith. The other electronic device (e.g., electronic devices 102 and 104 or server 106) may execute the requested functions or additional functions and transfer a result of the execution to the electronic device 101. The electronic device 101 may provide a requested function or service by processing the received result as it is or additionally. To that end, a cloud computing, distributed computing, or client-server computing technique may be used, for example.

Although FIG. 1 shows that the electronic device 101 includes the communication interface 170 to communicate with the external electronic device 104 or 106 via the network 162, the electronic device 101 may be independently operated without a separate communication function, according to an embodiment of the present disclosure.

For example, the event processing server module may include at least one of the components of the event processing module 180 and perform (or instead perform) at least one of the operations (or functions) conducted by the event processing module 180.

The event processing module 180 may process at least part of information obtained from other elements (e.g., the processor 120, the memory 130, the input/output interface 150, or the communication interface 170) and may provide the same to the user in various manners.

Although in FIG. 1 the event processing module 180 is shown to be a module separate from the processor 120, at least a portion of the event processing module 180 may be included or implemented in the processor 120 or at least one other module, or the overall function of the event processing module 180 may be included or implemented in the processor 120 shown or another processor. The event processing module 180 may perform operations according to embodiments of the present disclosure in interoperation with at least one program 140 stored in the memory 130.

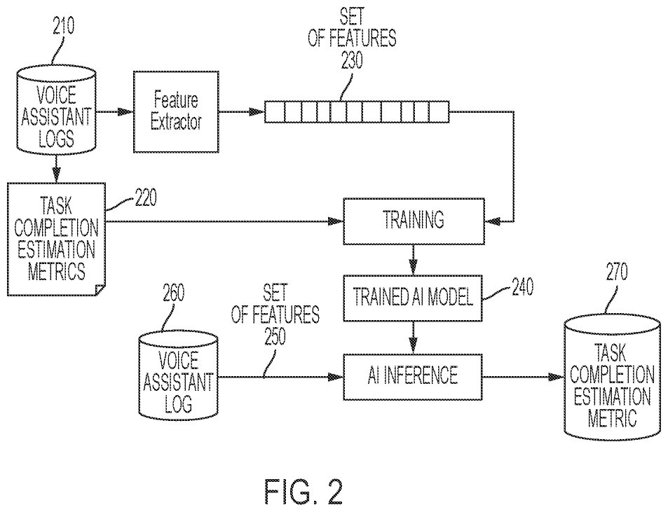

FIG. 2 is a diagram of a process of training an AI model, and identifying a task completion estimation metric using the trained AI model according to an example embodiment.

As shown in FIG. 2, a server 106 may obtain user voice assistant logs 210 respectively regarding user voice inputs of users of electronic devices 101 requesting voice assistants of the electronic devices 101 to perform tasks. The server 106 may obtain known task completion estimation metrics 220 that are respectively associated with corresponding voice assistant logs 210. Further, the server 106 may extract a respective set of features 230 from each of the voice assistant logs 210. The server 106 may train an AI model 240 using the extracted sets of features 230 of the voice assistant logs 210, and the known task completion estimation metrics 220 of the voice assistant logs 210. In this way, in real-time, the trained AI model 240 may obtain an extracted set of features 250 of a user voice assistant log 260 that is associated with an unknown task completion estimation metric, and identify a task completion estimation metric 270 that is indicative of a performance of a voice assistant in performing a task.

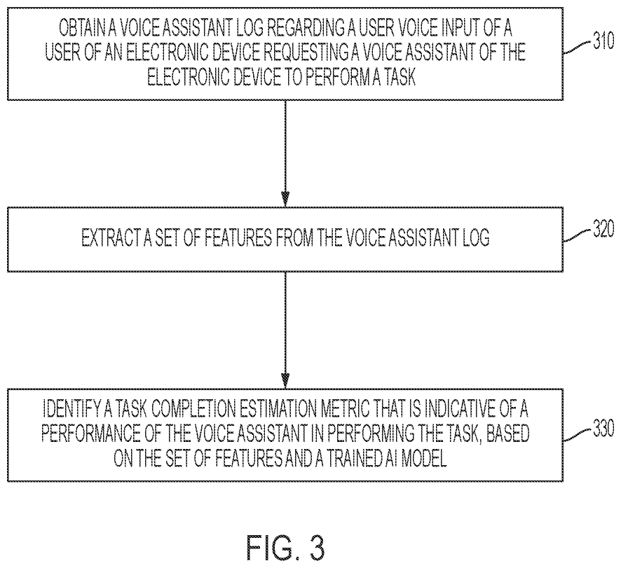

FIG. 3 is a flowchart of a process of identifying a task completion estimation metric using a trained AI model according to an example embodiment.

As shown in FIG. 3, the process may include obtaining a voice assistant log regarding a user voice input of a user of an electronic device requesting a voice assistant of the electronic device to perform a task (operation 310). The electronic device 101 may obtain the voice assistant log. Alternatively, the server 106 may obtain the voice assistant log.

The electronic device 101 may include a voice assistant. For example, the voice assistant may be a virtual assistant, an intelligent virtual assistant, an intelligent personal assistant, or the like. The voice assistant may be configured to perform a task using one or more applications of the electronic device 101. For example, the voice assistant may call a contact using a phone application, send a message to a contact using a messaging application, identify and output weather information using a weather application, identify and output appointment information using a calendar application, identify and output requested information using a web browsing application, or the like.

The user may provide a user voice input to the electronic device 101 requesting the voice assistant to perform a task. For example, the user may provide a user voice input of “call dad” requesting the voice assistant to call a father of the user. Based on the user voice input, the voice assistant may output a response to the user voice input and/or may perform the requested task. For example, the voice assistant may output “Okay, calling dad” via a speaker of the electronic device 101 and may call the father of the user using a telephone application of the electronic device 101. As another example, the voice assistant may be unable to perform the requested task based on the user voice input, and may request additional information from the user. For instance, the voice assistant may output “I'm sorry, but I did not hear that Can you please repeat?,” via the speaker of the electronic device 101 in order to request the user to repeat, or clarify, the user voice input. It should be understood that a particular interaction between a voice assistant and the user may include any type and number of user voice inputs, and any type and number of responses from the voice assistant.

The voice assistant log may be a set of data associated with a particular interaction between a user and a voice assistant. For example, a voice assistant log may include information identifying a user voice input of the user, a requested task, an application associated with the requested task, a time of day of the user voice input, a day of the week of the user voice input, a response of the voice assistant, whether the task was completed, a duration of the particular interaction between the user and the voice assistant, respective time stamps of the user voice input and the response of the voice assistant, or the like.

The electronic device 101 may generate the voice assistant log based on the user of the electronic device 101 interacting with the voice assistant, and may obtain the voice assistant log based on generating the voice assistant log. Additionally, the electronic device 101 may transmit the voice assistant log to the server 106. In this case, the server 106 may obtain the voice assistant log based on receiving the voice assistant log from the electronic device 101.

As further shown in FIG. 3, the process may include extracting a set of features from the voice assistant log (operation 320).

The electronic device 101 may extract a set of features from the voice assistant log. Alternatively, the server 106 may extract the set of features from the voice assistant log.

The set of features may include a latency value of the user voice input and a response of the voice assistant, an application associated with the task, a day of a week of the user voice input, an hour of a day of the user voice input, a bidirectional encoder representations from transformers (BERT) embedding for the user voice input, a BERT embedding for a response of the voice assistant, a sentiment of the user voice input, a sentiment of a subsequent user voice input, a similarity value between the user voice input and the subsequent user voice input, an identifier of whether the user voice input includes an interrogative word (e.g., “who,” “what,” “why,” etc.), a number of stop words (e.g., “a,” “the,” “is,” etc.) of the user voice input, a number of words of the user voice input, a number of user voice inputs of the user during the particular interaction, a number of responses of the voice assistant during the particular interaction, a duration of the particular interaction, whether the task was performed, or the like.

The set of features may include one or more of the foregoing delineated features, and may include any combination or permutation of the foregoing delineated features. Each feature of the set of features may be encoded to generate a feature vector.

As further shown in FIG. 3, the process may include identifying a task completion estimation metric that is indicative of a performance of the voice assistant in performing the task, based on the set of features and a trained AI model (operation 330).

The electronic device 101 may identify the task completion estimation metric, based on the set of features and a trained AI model. For example, the electronic device 101 may store the trained AI model, input the set of features into the trained AI model, and identify the task completion estimation metric based on an output of the trained AI model. Alternatively, the server 106 may identify the task completion estimation metric. For example, the server 106 may store the trained AI model, input the set of features into the trained AI model, and identify the task completion estimation metric based on an output of the trained AI model.

The trained AI model may be configured to obtain a set of features of a voice assistant log as an input, and output the task completion estimation metric. The trained AI model may be a convolution neural network (CNN), a deep neural network (DNN), a support vector machine (SVM), a K-nearest neighbor (KNN), a random forest, a gradient boosting technique, a linear regression technique, a feedforward neural network, a deep Q network, or the like. According to a non-limiting embodiment, the AI model may be a feedforward neural network including a combination of linear layers, dropout layers, and rectified linear unit (ReLU) activations. Further, the loss function may be a binary cross-entropy loss function.

The trained AI model may be trained using supervised learning, unsupervised learning, reinforcement learning, or the like. For example, the trained AI model may be trained using paired sets of features from training voice assistant logs and known task completion estimation metrics. The server 106 may train the AI model, and provide the trained AI model to the electronic device 101.

The trained AI model may obtain the set of features extracted from the voice assistant log, and may identify a task completion estimation metric based on the set of features. The trained AI model may be configured to assign weights to the features of the set of features, and may identify the task completion estimation metric based on assigning the weights to the features.

The trained AI model may identify the task completion estimation metric that is indicative of a performance of the voice assistant in performing the task. For example, the task completion estimation metric may be a score, a value, etc., that is indicative of the performance of the voice assistant in performing the task. As examples, a task completion estimation metric having a low score (e.g., “0”) may be indicative of the voice assistant being unable to perform the task, a task completion estimation metric having a high score (e.g., “1”) may be indicative of the voice assistant performing the task in a highly efficient and seamless manner, and a task completion estimation metric having a medium score (e.g., “0.5”) may be indicative of the voice assistant performing the task albeit in a non-efficient or non-seamless manner.

The task completion estimation metric may be indicative of a user satisfaction with the voice assistant. For example, a task completion estimation metric having a low score (e.g., “0”) may be indicative of the user being dissatisfied with the voice assistant, a task completion estimation metric having a high score (e.g., “1”) may be indicative of the user being highly satisfied with voice assistant, and a task completion estimation metric having a medium score (e.g., “0.5”) may be indicative of the user being indifferent towards the voice assistant.

The task completion estimation metric may be identified in real-time, or substantially in real-time. For example, the task completion estimation metric may be identified within a threshold time frame (e.g., one second, five seconds, ten seconds, etc.) of the end of the particular interaction between the user and the voice assistant, may be identified within a threshold time frame of the input of the user voice input, or the like.

The electronic device 101 may perform an action based on the task completion estimation metric. For example, the electronic device 101 transmit the task completion estimation metric to the server 106. In this way, task completion estimation metrics from electronic devices 101 may be aggregated and analyzed by the server 106. For example, the server 106 may provide, to an electronic device 101 associated with an administrator, information identifying various task completion estimation metrics from electronic devices 101 such as in the form of a dashboard. The information may include task completion estimation metrics that are aggregated on a region (e.g., city, country, etc.) basis, on a device (e.g., type of smartphone) basis, on an application basis, etc. Accordingly, voice assistants or applications associated with requested tasks that are associated with low task completion estimation metrics may be identified and improved.

The electronic device 101 may identify whether the task completion estimation metric is less than or equal to a threshold (e.g., “0.5,” “0.4,” 0.3,” etc.), and perform the action based on identifying that the task completion estimation metric is less than or equal to the threshold. In this case, the voice assistant may perform a different, but related, task in an effort to mitigate the user's experience. As an example, the voice assistant may output an option to call another person associated with the requested task, output an option to place a reservation at another restaurant, etc. As another example, the voice assistant may output information that is apologetic. For example, the voice assistant may output an apologetic emoticon, may express an apology, or the like.

In this way, the electronic device 101 may identify a task completion estimation metric using a trained AI model in real-time, and perform an action based on the identified task completion estimation metric.

Although FIG. 3 shows example operations of a process of identifying a task completion estimation metric using a trained AI model, the process may include additional operations, fewer operations, different operations, or differently arranged operations than those depicted in FIG. 3. Additionally, or alternatively, two or more of the operations of the process may be performed in parallel.

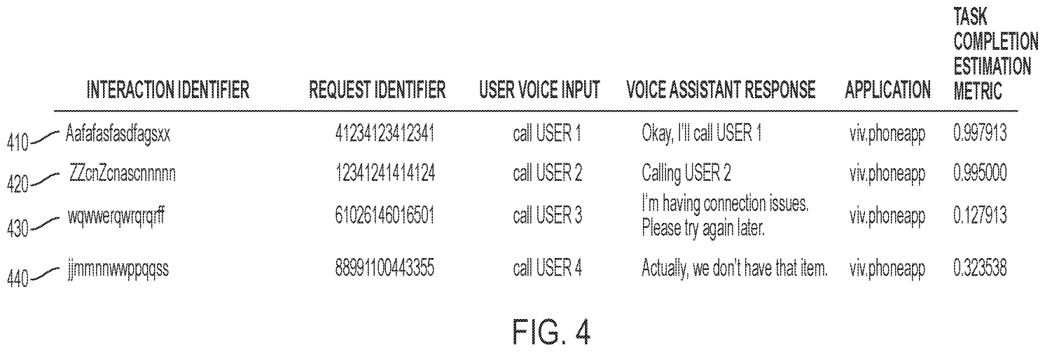

FIG. 4 is a diagram of voice assistant logs associated with task completion estimation metrics according to an example embodiment. As shown in FIG. 4, a voice assistant log may be associated with an interaction identifier that identifies the particular interaction between a user and a voice assistant, a request identifier that identifies a request to perform a task, a user voice input, a voice assistant response, an application associated with the request, and a task completion estimation metric.

As shown in FIG. 4, the voice assistant logs 410 and 420 are associated with high task completion estimation metrics because the voice assistants performed the requested tasks, and did so in a seamless manner. In contrast, the voice assistant logs 430 and 440 are associated with low task completion estimation metrics because the voice assistants did not perform the requested tasks, let alone in a seamless manner.

By identifying the respective task completion estimation metrics, the quality and efficiency of voice assistants may be improved. In this way, the example embodiments provide an improvement in the functioning of electronic devices 101 and an improvement in the utilization of processor and/or memory resources of electronic devices 101.

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term “component” is intended to be broadly construed as hardware, firmware, or a combination of hardware and software.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A method comprising:
obtaining a voice assistant log regarding a user voice input of a user of an electronic device requesting a voice assistant of the electronic device to perform a task;
extracting a set of features from the voice assistant log; and
identifying a task completion estimation metric that is indicative of a performance of the voice assistant in performing the task, based on the set of features and a trained artificial intelligence (AI) model.

2. The method of claim 1, wherein the set of features includes a latency value of the user voice input and a response of the voice assistant.

3. The method of claim 1, wherein the set of features includes an application associated with the task.

4. The method of claim 1, wherein the set of features includes a day of a week of the user voice input.

5. The method of claim 1, wherein the set of features includes an hour of a day of the user voice input.

6. The method of claim 1, wherein the set of features includes a first bidirectional encoder representations from transformers (BERT) embedding for the user voice input, and a second BERT embedding for a response of the voice assistant.

7. The method of claim 1, wherein the set of features includes a sentiment of the user voice input.

8. The method of claim 1, wherein the set of features includes a similarity value between the user voice input and a subsequent user voice input.

9. The method of claim 1, wherein the set of features includes an identifier of whether the user voice input includes an interrogative word.

10. The method of claim 1, wherein the set of features includes a number of stop words of the user voice input.

11. The method of claim 1, wherein the set of features includes a number of words of the user voice input.

12. The method of claim 1, wherein the trained AI model is trained using training virtual assistant logs that are paired with known task completion estimation metrics.

13. The method of claim 1, wherein the task completion estimation metric is indicative of a user satisfaction with the voice assistant.

14. The method of claim 1, further comprising:
performing an action based on the task completion estimation metric.

15. A device comprising:
a memory configured to store instructions; and
a processor configured to execute the instructions to:
obtain a voice assistant log regarding a user voice input of a user of an electronic device requesting a voice assistant of the electronic device to perform a task;
extract a set of features from the voice assistant log; and
identify a task completion estimation metric that is indicative of a performance of the voice assistant in performing the task, based on the set of features and a trained artificial intelligence (AI) model.

16. The device of claim 15, wherein the trained AI model is trained using training virtual assistant logs that are paired with known task completion estimation metrics.

17. The device of claim 15, wherein the task completion estimation metric is indicative of a user satisfaction with the voice assistant.

18. The device of claim 15, wherein the processor is further configured to:
perform an action based on the task completion estimation metric.

19. A non-transitory computer-readable medium storing instructions, the instructions comprising: one or more instructions that, when executed by one or more processors of an electronic device, cause the one or more processors to:
obtain a voice assistant log regarding a user voice input of a user of an electronic device requesting a voice assistant of the electronic device to perform a task;
extract a set of features from the voice assistant log; and
identify a task completion estimation metric that is indicative of a performance of the voice assistant in performing the task, based on the set of features and a trained artificial intelligence (AI) model.

20. The non-transitory computer-readable medium of claim 19, wherein the trained AI model is trained using training virtual assistant logs that are paired with known task completion estimation metrics.
